(19) United States
(12) Patent Application Publication
(10) Pub. No.: US 2023/0417593 A1
(43) Pub. Date: Dec. 28, 2023

(54) OPTICAL FIBER SENSING SYSTEM, OPTICAL FIBER SENSING METHOD, AND OPTICAL FIBER SENSING DEVICE

(71) Applicant: NEC Corporation, Minato-ku, Tokyo (JP)

(72) Inventors: Tadayuki Iwano, Tokyo (JP); Yoshiaki Aono, Tokyo (JP); Yoshinori Kitahara, Tokyo (JP); Satoru Ishii, Tokyo (JP)

(73) Assignee: NEC Corporation, Minato-ku, Tokyo (JP)

(21) Appl. No.: 18/037,497

(22) PCT Filed: Nov. 24, 2020
(86) PCT No.: PCT/JP2020/043629

§ 371 Date: May 17, 2023

(51) Int. Cl. G01H 9/00

(52) U.S. Cl. CPC G01H 9/004

(57) ABSTRACT

An optical fiber sensing system according to the present disclosure includes an optical fiber network (10) that detects sensing data, a communication unit (21) that receives an optical signal from the optical fiber network (10), an identification unit (22) that identifies status information appropriate to a service providing destination from among a plurality of pieces of status information, an analysis unit (23) that analyzes the identified status information, based on sensing data superimposed on the optical signal, by using an analysis method related to the identified status information among a plurality of analysis methods, and a providing unit (24) that provides the identified status information to the service providing destination.

### TECHNICAL FIELD

The present disclosure relates to an optical fiber sensing system, an optical fiber sensing method, and an optical fiber sensing device.

### BACKGROUND ART

In recent years, a technique of receiving an optical signal from an optical fiber network including an optical fiber and analyzing various pieces of status information, based on sensing data (e.g., vibration data, sound data, temperature data, etc.) superimposed on the optical signal has attracted attention.

The status information is, for example, a behavior of a person, a vehicle, or an animal, a status of a structure such as a utility pole, a status of a track or a road, a status of weather, or the like.

Further, the optical fiber is laid on, for example, a structure such as a utility pole, a road, a track, a seabed, or the like.

However, some of pieces of the status information is preferably provided only to a specific service providing destination. For example, status information relating to privacy of an enterprise needs to be provided only to a service providing destination being the enterprise, and needs to be avoided from leaking to other service providing destinations.

Therefore, there is a need to provide status information appropriate to a service providing destination to the service providing destination.

As a related art, a technique described in Patent Literature 1 is cited. In the technique described in Patent Literature 1, a privacy protection mode and a normal mode are switched depending on a position of a subject. For example, when the subject moves to a privacy space such as a toilet, the mode is switched to the privacy protection mode, and during this time, measurement is interrupted or measurement data are not recorded.

### CITATION LIST

### Patent Literature

[Patent Literature 1] International Patent Publication No. WO 2015/056300

### SUMMARY OF INVENTION

### Technical Problem

As described above, there is a need to provide status information appropriate to a service providing destination to the service providing destination. However, in the technique described in Patent Literature 1, since measurement during the privacy protection mode is interrupted or measurement data are not recorded, desired status information cannot be acquired in the first place, and the above-described need cannot be met.

An object of the present disclosure is to solve the above-described problem and provide an optical fiber sensing system, an optical fiber sensing method, and an optical fiber sensing device that are capable of providing status information appropriate to a service providing destination to the service providing destination.

### Solution to Problem

An optical fiber sensing system according to one aspect includes:
an optical fiber network configured to detect sensing data;
a communication unit configured to receive an optical signal from the optical fiber network;
an identification unit configured to identify status information appropriate to a service providing destination from among a plurality of pieces of status information;
an analysis unit configured to analyze the identified status information, based on sensing data superimposed on the optical signal, by using an analysis method related to the identified status information among a plurality of analysis methods; and
a providing unit configured to provide the identified status information to the service providing destination.

An optical fiber sensing method according to one aspect is an optical fiber sensing method performed by an optical fiber sensing device and includes:
a receiving step of receiving an optical signal from an optical fiber network configured to detect sensing data;
an identification step of identifying status information appropriate to a service providing destination from among a plurality of pieces of status information;
an analysis step of analyzing the identified status information, based on sensing data superimposed on the optical signal, by using an analysis method related to the identified status information among a plurality of analysis methods; and
a providing step of providing the identified status information to the service providing destination.

An optical fiber sensing device according to one aspect includes:
a communication unit configured to receive an optical signal from an optical fiber network configured to detect sensing data;
an identification unit configured to identify status information appropriate to a service providing destination from among a plurality of pieces of status information;
an analysis unit configured to analyze the identified status information, based on sensing data superimposed on the optical signal, by using an analysis method related to the identified status information among a plurality of analysis methods; and
a providing unit configured to provide the identified status information to the service providing destination.

### Advantageous Effects of Invention

According to the above-described aspects, it is possible to achieve effects of providing an optical fiber sensing system, an optical fiber sensing method, and an optical fiber sensing device that enable providing status information appropriate to a service providing destination to the service providing destination.

### BRIEF DESCRIPTION OF DRAWINGS

FIG. 1 is a diagram illustrating a configuration example of an optical fiber sensing system according to a first example embodiment;

FIG. 2 is a diagram illustrating an example of a region DB held by an analysis unit according to the first example embodiment;

FIG. 3 is a flowchart illustrating an example of a flow of an operation of the optical fiber sensing system according to the first example embodiment;

FIG. 4 is a diagram illustrating a configuration example of an optical fiber sensing system according to a second example embodiment;

FIG. 5 is a diagram illustrating an example of a vibration pattern extracted by an analysis unit according to the second example embodiment;

FIG. 6 is a diagram illustrating an example of a vibration pattern extracted by the analysis unit according to the second example embodiment;

FIG. 7 is a diagram illustrating an example of a utility pole DB held by the analysis unit according to the second example embodiment;

FIG. 8 is a diagram illustrating an example of a monitoring exclusion target DB held by an identification unit according to the second example embodiment;

FIG. 9 is a diagram illustrating a configuration example of an optical fiber sensing system according to another example embodiment; and

FIG. 10 is a block diagram illustrating an example of a hardware configuration of a computer that achieves the optical fiber sensing device according to the example embodiment.

### EXAMPLE EMBODIMENT

Hereinafter, example embodiments of the present disclosure will be explained with reference to the drawings. Note that the following description and the drawings are omitted and simplified as appropriate for clarity of explanation. In the following drawings, the same elements are denoted by the same reference numerals, and redundant explanations are omitted as necessary.

### First Example Embodiment

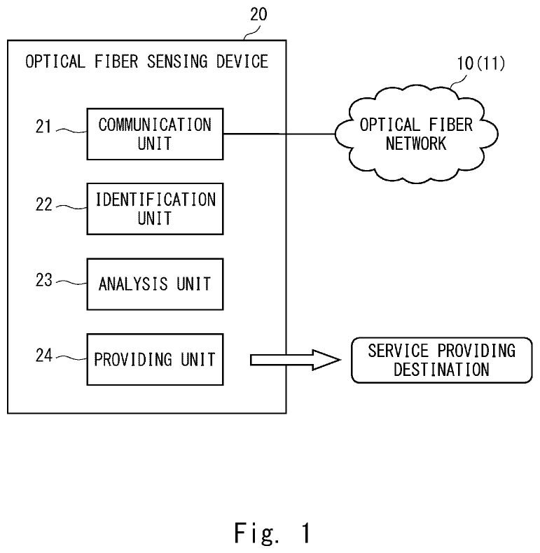

First, a configuration example of an optical fiber sensing system according to a first example embodiment will be explained with reference to FIG. 1.

As illustrated in FIG. 1, the optical fiber sensing system according to the first example embodiment includes an optical fiber network 10 and an optical fiber sensing device 20. Further, the optical fiber sensing device 20 includes a communication unit 21, an identification unit 22, an analysis unit 23, and a providing unit 24.

The optical fiber network 10 is composed of one or more optical fibers 11. Note that the optical fiber 11 may be an optical fiber dedicated to sensing, or may be an optical fiber for both communication and sensing. Further, the optical fiber 11 may be an existing optical fiber or may be a newly installed optical fiber.

A location where the optical fiber 11 can be laid is, for example, as follows.
Structures such as a utility pole, a bridge, a tunnel, a pipe and a dam
Track, road
Underground, seabed

The status information that can be analyzed by the optical fiber sensing system according to the first example embodiment is, for example, a plurality of pieces of status information as follows.
Status including deterioration of structures such as a utility pole, a bridge, a tunnel, a pipe, and a dam.
Status including deterioration of a track and a road
Track and road conditions
Behavior of a person, a vehicle, an animal, etc.
Occurrence of natural disaster such as volcanic eruption, earthquake, sediment disaster, ground subsidence, depression/rock falling, erosion, lake explosion, wind and flood damage, wind damage, flood damage, salt damage, snow damage, snow blow, freezing damage, lightning, high temperature (heat wave, extreme heat, warm winter), low temperature (severe winter, cold summer), or natural fire, and damage caused by natural disaster
Occurrence of power failure, construction, etc.
Weather, temperature, ground temperature, air volume and precipitation
Communication failure

The communication unit 21 receives an optical signal from the optical fiber network 10. For example, the communication unit 21 transmits pulsed light to the optical fiber 11 constituting the optical fiber network 10, and receives backscattered light generated when the pulsed light is transmitted through the optical fiber 11 as an optical signal.

Herein, when vibration, sound, temperature, and the like are generated around the optical fiber 11, the vibration, sound, temperature, and the like are transmitted to the optical fiber 11, and characteristics (e.g., wavelength) of the optical signal transmitted through the optical fiber 11 are changed. Therefore, the optical fiber 11 can detect sensing data including vibration data, sound data, temperature data, and the like, and the sensing data are superimposed on an optical signal transmitted through the optical fiber 11.

The analysis unit 23 can use a plurality of analysis methods associated with the plurality of pieces of status information described above. When analyzing certain status information, the analysis unit 23 analyzes the status information, based on the sensing data superimposed on the optical signal received by the communication unit 21 by using an analysis method related to the status information.

Specifically, as described above, the sensing data superimposed on the optical signal include vibration data, sound data, temperature data, and the like, but the vibration data alone include a unique pattern of vibration related to various status information. For example, when the optical fiber 11 is laid on a utility pole, the sensing data (vibration data) include a unique pattern of vibration appropriate to a deteriorated status of the utility pole, a unique pattern of vibration appropriate to a traffic condition of a vehicle traveling in the vicinity of the utility pole, a natural pattern of vibration appropriate to a status of weather, and the like. A unique pattern associated with certain status information is a unique pattern that dynamically fluctuates according to a status indicated by the status information.

When analyzing certain status information, the analysis unit 23 analyzes the status information by using an analysis method related to the status information, as described above. This analysis method is, for example, a method of extracting a unique pattern related to the status information from the sensing data superimposed on the optical signal received by the communication unit 21 and analyzing the extracted unique pattern, thereby analyzing the status information.

However, some of the status information is preferably provided only to a specific service providing destination. For example, the status information relating to the privacy of an enterprise needs to be provided only to a service providing destination that is the enterprise, and needs be avoided from leaking to another service providing destination.

Therefore, the identification unit 22 identifies the status information appropriate to the service providing destination from among a plurality of pieces of status information. At this time, the identification unit 22 may identify the status information of the monitoring exclusion target from among the plurality of pieces of status information, and identify the status information acquired by excluding the status information of the monitoring exclusion target from the plurality of pieces of status information as the status information appropriate to the service providing destination.

The status information of the monitoring exclusion target is, for example, status information relating to confidentiality of national, local governments, and the like, status information relating to privacy of individuals and enterprises, or the like. Note that the state information of the monitoring exclusion target may be defined for each service providing destination according to a policy of the service providing destination or the like, or the status information of the monitoring exclusion target common to the service providing destination may be defined.

The analysis unit 23 extracts a unique pattern related to the identified status information from the sensing data superimposed on the optical signal received by the communication unit 21 by using an analysis method related to the status information identified by the identification unit 22, and analyzes the extracted unique pattern, thereby analyzing the identified status information.

However, the sensing data include all data such as vibration generated around the optical fiber 11. Therefore, among the sensing data, there are data that are not appropriate to be used for analyzing the status information.

Therefore, the analysis unit 23 may exclude sensing data of a monitoring exclusion target from the sensing data superimposed on the optical signal received by the communication unit 21, and analyze the status information identified by the identification unit 22, by using remaining sensing data.

The sensing data of the monitoring exclusion target include sensing data detected at facilities of the national and local governments, sensing data relating to personal information of individuals and enterprises, and the like. Note that the sensing data of the monitoring exclusion target may be sensing data detected at a specific position or region, sensing data detected at a specific time zone, or sensing data of a specific frequency.

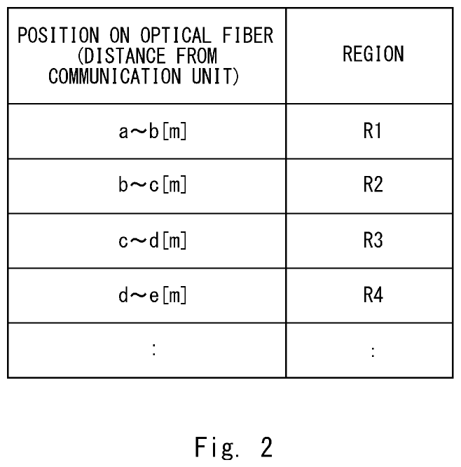

At this time, the analysis unit 23 can identify a position (distance from the communication unit 21) on the optical fiber 11 where the sensing data superimposed on the optical signal are detected, based on a time difference between a time at which pulsed light is transmitted to the optical fiber 11 by the communication unit 21 and a time at which the optical signal is received from the optical fiber 11 by the communication unit 21. Further, as illustrated in FIG. 2, the analysis unit 23 may hold in advance a region database (DB) in which the position on the optical fiber 11 (distance from the communication unit 21) and an identifier of each region on a map are associated with each other. As a result, the analysis unit 23 can determine in which region on the map the sensing data are detected, i.e., which region the status information is being analyzed.

The providing unit 24 provides the service providing destination with the status information identified by the identification unit 22 and analyzed by the analysis unit 23.

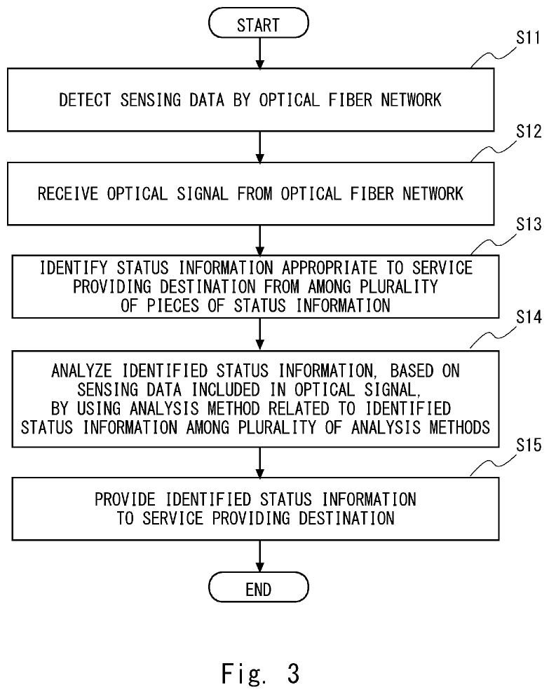

Next, an example of an operation flow of the optical fiber sensing system according to the first example embodiment will be explained with reference to FIG. 3.

As illustrated in FIG. 3, first, the optical fiber network 10 (optical fiber 11) detects sensing data (step S11).

Subsequently, the communication unit 21 receives an optical signal on which the sensing data are superimposed from the optical fiber network 10 (the optical fiber 11) (step S12).

Subsequently, the identification unit 22 identifies status information appropriate to a service providing destination from among a plurality of pieces of status information that can be analyzed by the optical fiber sensing system according to the first example embodiment (step S13). As described above, this identification may be performed by a method of identifying status information of a monitoring exclusion target.

Subsequently, the analysis unit 23 analyzes the identified status information, based on the sensing data superimposed on the optical signal received by the communication unit 21, by using an analysis method related to the status information identified by the identification unit 22 among the plurality of analysis methods (step S14). As described above, this analysis may be performed by a method of extracting a unique pattern related to the identified status information from the sensing data and analyzing the extracted unique pattern.

Thereafter, the providing unit 24 provides the service providing destination with the status information identified by the identification unit 22 and analyzed by the analysis unit 23 (step S15).

As described above, according to the first example embodiment, the identification unit 22 identifies the status information appropriate to the service providing destination from among the plurality of pieces of status information. The analysis unit 23 analyzes the identified status information, based on the sensing data superimposed on the received optical signal by using the analysis method related to the identified status information among the plurality of analysis methods. Thus, the status information appropriate to the service providing destination can be provided to the service providing destination.

Further, according to the first example embodiment, the identification unit 22 may identify the status information of the monitoring exclusion target from among the plurality of pieces of status information, and identify the status information appropriate to the service providing destination, based on the status information of the monitoring exclusion target. As a result, it is possible to prevent the status information of the monitoring exclusion target, which is status information or the like relating to privacy of an enterprise, from leaking to a service providing destination that is another enterprise.

Further, according to the first example embodiment, the analysis unit 23 may exclude sensing data of a monitoring exclusion target from the sensing data, and analyze the identified status information, based on remaining sensing data. Thus, it is possible to avoid that the sensing data of the monitoring exclusion target, which are the sensing data or the like detected in a national facility, are used for the analysis of the status information.

### Second Example Embodiment

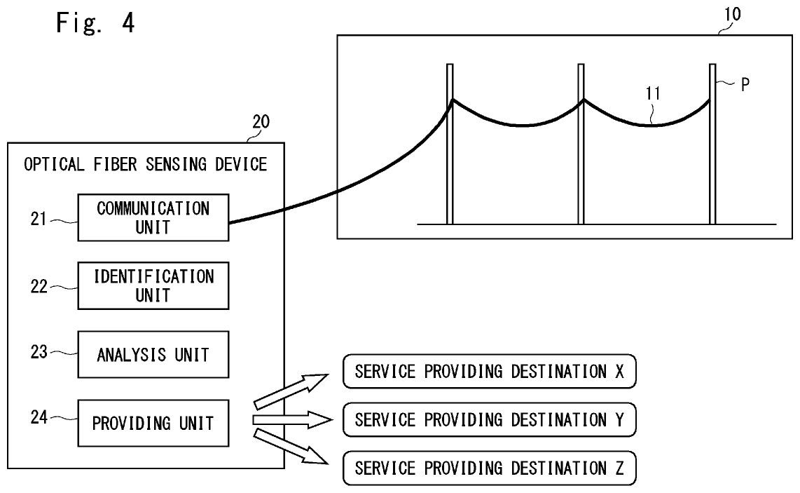

Next, a configuration example of an optical fiber sensing system according to a second example embodiment will be explained with reference to FIG. 4.

As illustrated in FIG. 4, the optical fiber sensing system according to the second example embodiment is an example in which the optical fiber sensing system according to the first example embodiment described above is more embodied.

Specifically, in the optical fiber sensing system according to the second example embodiment, an optical fiber network 10 is constituted by an optical fiber 11 laid on a utility pole P, and there are three service providing destinations X, Y, and Z.

The following three pieces of status information can be analyzed by the optical fiber sensing system according to the second example embodiment.
Status information A: Deterioration status of the utility pole P
Status information B: Traffic condition of vehicles traveling near the utility pole P
Status information C: Weather status

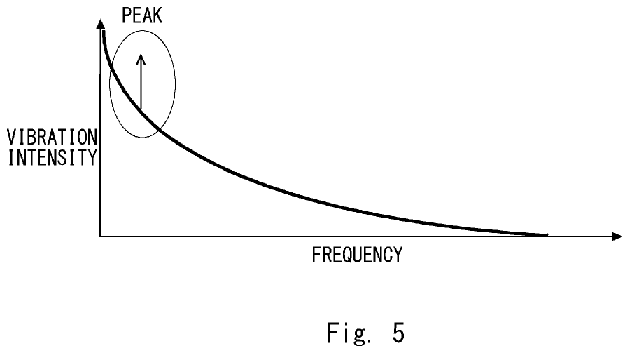

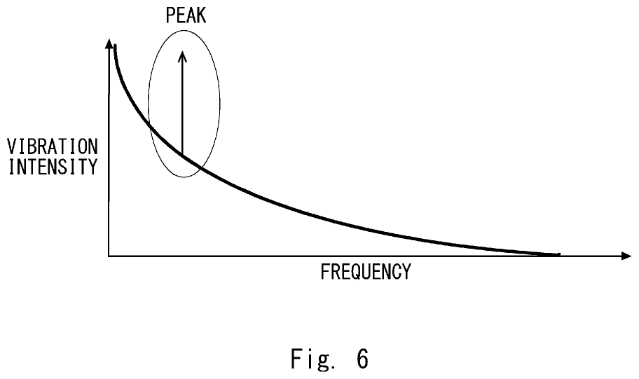

Herein, as an example, an analysis method of analyzing status information A indicating a deterioration status of the utility pole P will be explained. First, the analysis unit 23 extracts a vibration pattern as illustrated in FIGS. 5 and 6 from sensing data superimposed on an optical signal received by a communication unit 21. FIGS. 5 and 6 are vibration patterns after Fast Fourier Transform (FFT) of each vibration pattern in which a horizontal axis indicates time and a vertical axis indicates vibration intensity. In the vibration patterns illustrated in FIGS. 5 and 6, the horizontal axis indicates a frequency and the vertical axis indicates vibration intensity.

In the vibration patterns illustrated in FIGS. 5 and 6, a peak of vibration intensity occurs. A magnitude of the peak of the vibration intensity and a frequency at which the peak occurs differ depending on the deterioration status of the utility pole P. Specifically, in the status in which the utility pole P is deteriorated (FIG. 6), the magnitude of the peak of the vibration intensity is larger than that in a status in which the utility pole P is normal (FIG. 5), and the frequency at which the peak occurs is shifted to a high frequency side.

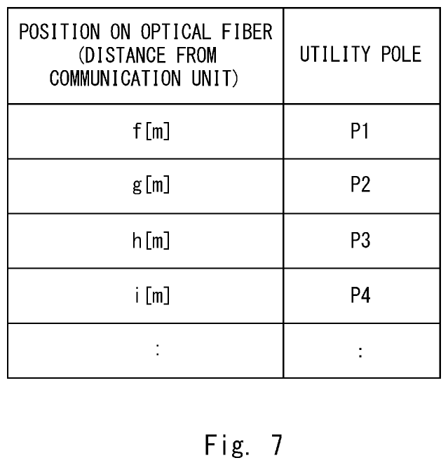

Therefore, the analysis unit 23 determines the deterioration status of the utility pole P, based on the magnitude of the peak of the vibration intensity and the frequency at which the peak occurs. As illustrated in FIG. 7, the analysis unit 23 may hold in advance a utility pole DB in which a position on the optical fiber 11 (a distance from the communication unit 21) and an identifier of each utility pole P are associated with each other. As a result, the analysis unit 23 can determine in which of the utility poles P the sensing data have been detected, i.e., of which of the utility poles P the deterioration status is being analyzed.

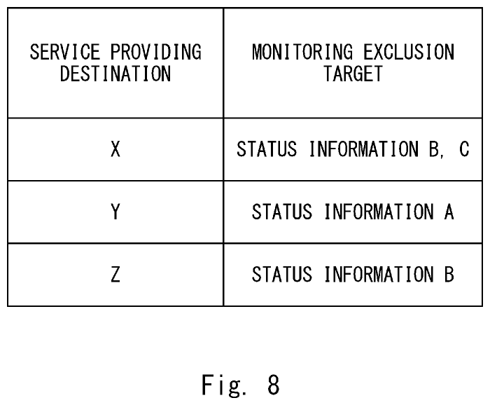

Further, in the optical fiber sensing system according to the second example embodiment, the status information of the monitoring exclusion target is defined for each of the service providing destinations X, Y, and Z, and the identification unit 22 holds in advance a monitoring exclusion target DB in which identifiers of the service providing destinations X, Y, and Z and the status information of the monitoring exclusion target of each of the service providing destinations X, Y, and Z are associated with each other, as illustrated in FIG. 8.

In the optical fiber sensing system according to the second example embodiment, it is assumed that the sensing data of the monitoring exclusion target are defined as sensing data detected in a region R1 (see FIG. 2), and the analysis unit 23 holds information (not illustrated) of the sensing data of the monitoring exclusion target in advance.

An operation flow of the optical fiber sensing system according to the second example embodiment is the same as that of the above-described first example embodiment illustrated in FIG. 3. Specifically, it is as follows.

### Step S11:

First, the optical fiber network 10 (optical fiber 11) detects sensing data.

### Step S12:

Subsequently, the communication unit 21 receives an optical signal on which sensing data are superimposed from the optical fiber network 10 (optical fiber 11).

### Step S13:

Subsequently, the identification unit 22 refers to the monitoring exclusion target DB in FIG. 8 and identifies status information appropriate to each of the service providing destinations X, Y, and Z in random order.

According to the monitoring exclusion target DB in FIG. 8, for example, a monitoring exclusion target of the service providing destination X is the status information B and C. Also, as for the identification unit 22, the status information A, B and C can be analyzed by the optical fiber sensing system according to the second example embodiment. Therefore, the status information A excluding the status information B and C from the status information A, B and C is identified as the status information appropriate to the service providing destination X. Similarly, the identification unit 22 identifies the status information B and C appropriate to the service providing destination Y, and identifies the status information A and C appropriate to the service providing destination Z.

### Step S14:

Subsequently, the analysis unit 23 analyzes each of the status information A, B, and C in random order. For example, the status information A indicating the deterioration status of the utility pole P is analyzed as follows.

First, the analysis unit 23 acquires sensing data superimposed on the optical signal received by the communication unit 21. However, in the second example embodiment, the sensing data detected in the region R1 (see FIG. 2) is defined as the sensing data of the monitoring exclusion target.

Therefore, the analysis unit 23 subsequently removes the sensing data detected in the region R1 from the sensing data acquired above. Hereinafter, the removed sensing data are referred to as remaining sensing data.

Subsequently, the analysis unit 23 analyzes the status information A by using an analysis method related to the status information A. Specifically, the analysis unit 23 extracts the vibration pattern as illustrated in FIGS. 5 and 6 from the remaining sensing data, and analyzes the deterioration status of the utility pole P, based on the magnitude of the peak of vibration intensity in the extracted vibration pattern and the frequency at which the peak occurs. At this time, the analysis unit 23 can determine which of the utility poles P the deterioration status is being analyzed by referring to the utility poles DB illustrated in FIG. 7.

Thus, the analysis of the status information A is completed. The analysis unit 23 analyzes the other status information B and C as well by using an analysis method related to the status information B and C.

### Step S15:

Thereafter, the providing unit 24 provides the status information A to the service providing destination X in random order, provides the status information B and C to the service providing destination Y, and provides the status information A and C to the service providing destination Z.

The optical fiber sensing system according to the second example embodiment is an example in which the optical fiber sensing system according to the first example embodiment described above is more embodied. Therefore, according to the second example embodiment, the same effects as those of the first example embodiment described above can be acquired. The specific effects acquired in the second example embodiment are as follows.
The status information appropriate to the service providing destinations X, Y, and Z can be provided to each of the service providing destinations X, Y, and Z.
It is possible to avoid the status information B and C of the monitoring exclusion target by the service providing destination X from leaking to the service providing destination X. Similarly, the status information A can be avoided from leaking to the service providing destination Y, and the status information B can be avoided from leaking to the service providing destination Z.
It is possible to avoid that the sensing data of the monitoring exclusion target, which are the sensing data detected in the region R1 (see FIG. 2), are used for analysis.

### Other Example Embodiment

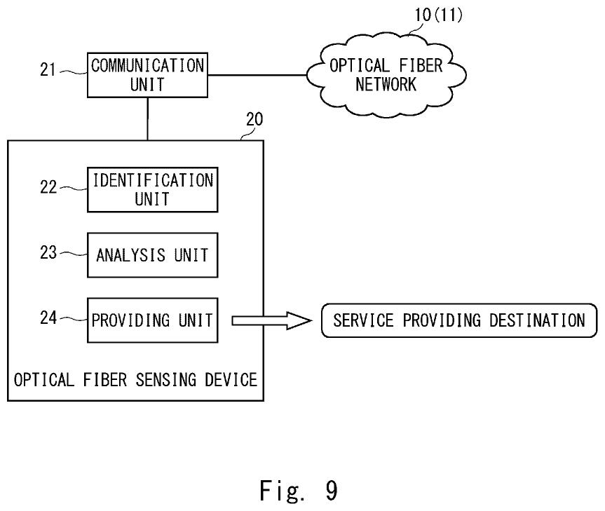

In the first and second example embodiments described above, the communication unit 21 is provided inside the optical fiber sensing device 20, but the present invention is not limited thereto. The communication unit 21 may be separated from the optical fiber sensing device 20. FIG. 9 illustrates a configuration example of an optical fiber sensing system in which the communication unit 21 is separated from the optical fiber sensing device 20. In the optical fiber sensing system illustrated in FIG. 9, the optical fiber sensing device 20 can be installed at a location away from the communication unit 21, and can be disposed on, for example, a cloud.

### <Hardware Configuration of Optical Fiber Sensing Device>

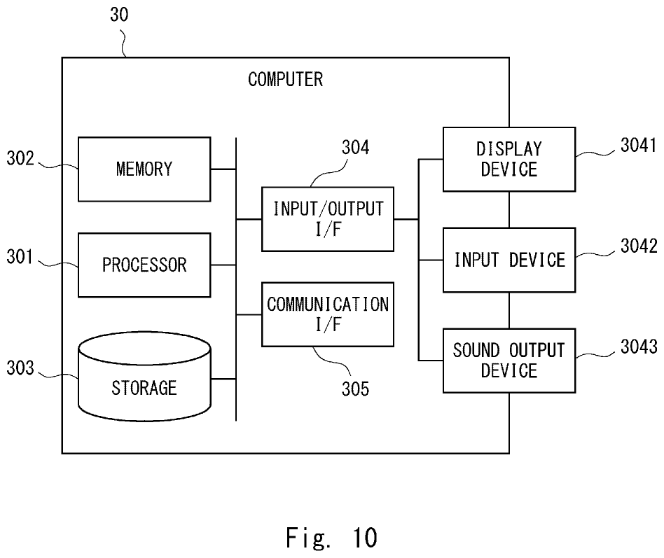

Next, with reference to FIG. 10, a hardware configuration of a computer 30 that achieves the optical fiber sensing device 20 according to the first and second example embodiments will be explained.

As illustrated in FIG. 10, the computer 30 includes a processor 301, a memory 302, a storage 303, an input/output interface (input/output I/F) 304, a communication interface (communication I/F) 305, and the like. The processor 301, the memory 302, the storage 303, the input/output interface 304, and the communication interface 305 are connected by a data transmission path for transmitting and receiving data to and from each other.

The processor 301 is, for example, an arithmetic processor such as a Central Processing Unit (CPU) or a Graphics Processing Unit (GPU). The memory 302 is, for example, a memory such as a Random Access Memory (RAM) or a Read Only Memory (ROM). The storage 303 is, for example, a storage device such as a Hard Disk Drive (HDD), a Solid State Drive (SSD), or a memory card. The storage 303 may be a memory such as a RAM or a ROM.

The storage 303 stores a program for achieving functions of components included in the optical fiber sensing device 20. The processor 301 achieves each of the functions of the components included in the optical fiber sensing device 20 by executing these programs. Herein, the processor 301 may read these programs onto the memory 302 and execute them, or may execute them without reading them onto the memory 302 when executing the above programs. The memory 302 and the storage 303 also serve to store information and data held by the components included in the optical fiber sensing device 20.

In addition, the above-described programs can be stored by using various types of non-transitory computer readable media and supplied to a computer (including the computer 30). The non-transitory computer readable media include various types of tangible storage media. Examples of the non-transitory computer readable media include magnetic recording media (e.g., flexible disks, magnetic tapes, hard disk drives), magneto-optical recording media (e.g., magneto-optical disks), CD-ROM (Compact Disc-ROM), CD-R (CD-Recordable), CD-R/W (CD-ReWritable), and semiconductor memories (e.g., mask ROM, PROM (Programmable ROM), EPROM (Erasable PROM), flash ROM, RAM). The program may also be provided to the computer by various types of transitory computer readable media. Examples of transitory computer readable media include electrical signals, optical signals, and electromagnetic waves. The transitory computer readable medium can supply the program to the computer via a wired communication path such as an electric wire and an optical fiber, or a wireless communication path.

The input/output interface 304 is connected to a display device 3041, an input device 3042, a sound output device 3043, and the like. The display device 3041 is a device, such as a Liquid Crystal Display (LCD), a Cathode Ray Tube (CRT) display, or a monitor, that displays a screen associated to drawing data processed by the processor 301. The input device 3042 is a device that receives an operation input from an operator, and is, for example, a keyboard, a mouse, a touch sensor, or the like. The display device 3041 and the input device 3042 may be integrated and achieved as a touch panel. The sound output device 3043 is a device, such as a speaker, that outputs sound associated to sound data processed by the processor 301.

The communication interface 305 transmits and receives data to and from an external device. For example, the communication interface 305 communicates with an external device via a wired communication path or a wireless communication path.

Although the present disclosure has been explained with reference to the example embodiments, the present disclosure is not limited to the above-described example embodiments. Various changes that can be understood by a person skilled in the art within the scope of the present disclosure can be made to the configuration and details of the present disclosure.

In addition, some or all of the above-described example embodiments may be described as the following supplementary notes, but are not limited thereto.

### Supplementary Note 1

An optical fiber sensing system comprising:
an optical fiber network configured to detect sensing data;
a communication unit configured to receive an optical signal from the optical fiber network;
an identification unit configured to identify status information appropriate to a service providing destination from among a plurality of pieces of status information;
an analysis unit configured to analyze the identified status information, based on sensing data superimposed on the optical signal, by using an analysis method related to the identified status information among a plurality of analysis methods; and
a providing unit configured to provide the identified status information to the service providing destination.

### Supplementary Note 2

The optical fiber sensing system according to Supplementary Note 1, wherein the identification unit identifies status information of a monitoring exclusion target from among the plurality of pieces of status information, and identifies status information appropriate to the service providing destination, based on the identified status information of the monitoring exclusion target.

### Supplementary Note 3

The optical fiber sensing system according to Supplementary Note 1, wherein the identification unit identifies status information of a monitoring exclusion target appropriate to the service providing destination from among the plurality of pieces of status information, and identifies status information appropriate to the service providing destination, based on the identified status information of the monitoring exclusion target.

### Supplementary Note 4

The optical fiber sensing system according to any one of Supplementary Notes 1 to 3, wherein the analysis unit excludes sensing data of a monitoring exclusion target, from among sensing data superimposed on the optical signal, and analyzes the identified status information, based on remaining sensing data.

### Supplementary Note 5

The optical fiber sensing system according to any one of Supplementary Notes 1 to 4, wherein the analysis method related to the identified status information is a method of extracting a pattern related to the identified status information from sensing data superimposed on the optical signal, and analyzing the identified status information, based on the extracted pattern.

### Supplementary Note 6

An optical fiber sensing method performed by an optical fiber sensing device, the method comprising:
a receiving step of receiving an optical signal from an optical fiber network configured to detect sensing data;
an identification step of identifying status information appropriate to a service providing destination from among a plurality of pieces of status information;
an analysis step of analyzing the identified status information, based on sensing data superimposed on the optical signal, by using an analysis method related to the identified status information among a plurality of analysis methods; and
a providing step of providing the identified status information to the service providing destination.

### Supplementary Note 7

The optical fiber sensing method according to Supplementary Note 6, wherein the identification step includes identifying status information of a monitoring exclusion target from among the plurality of pieces of status information, and identifying status information appropriate to the service providing destination, based on the identified status information of the monitoring exclusion target.

### Supplementary Note 8

The optical fiber sensing method according to Supplementary Note 6, wherein the identification step includes identifying status information of a monitoring exclusion target appropriate to the service provision destination from among the plurality of pieces of status information, and identifying status information appropriate to the service provision destination, based on the identified status information of the monitoring exclusion target.

### Supplementary Note 9

The optical fiber sensing method according to any one of Supplementary Notes 6 to 8, wherein the analysis step includes excluding sensing data of a monitoring exclusion target from among sensing data superimposed on the optical signal, and analyzing the identified status information, based on remaining sensing data.

### Supplementary Note 10

The optical fiber sensing method according to any one of Supplementary Notes 6 to 9, wherein the analysis method related to the identified status information is a method of extracting a pattern related to the identified status information from sensing data superimposed on the optical signal, and analyzing the identified status information, based on the extracted pattern.

### Supplementary Note 11

An optical fiber sensing device comprising:
a communication unit configured to receive an optical signal from an optical fiber network configured to detect sensing data;
an identification unit configured to identify status information appropriate to a service providing destination from among a plurality of pieces of status information;
an analysis unit configured to analyze the identified status information, based on sensing data superimposed on the optical signal, by using an analysis method related to the identified status information among a plurality of analysis methods; and
a providing unit configured to provide the identified status information to the service providing destination.

### Supplementary Note 12

The optical fiber sensing device according to Supplementary Note 11, wherein the identification unit identifies status information of a monitoring exclusion target from among the plurality of pieces of status information, and identifies status information appropriate to the service providing destination, based on the identified status information of the monitoring exclusion target.

### Supplementary Note 13

The optical fiber sensing device according to Supplementary Note 11, wherein the identification unit identifies status information of a monitoring exclusion target appropriate to the service providing destination from among the plurality of pieces of status information, and identifies status information appropriate to the service providing destination, based on the identified status information of the monitoring exclusion target.

### Supplementary Note 14

The optical fiber sensing device according to any one of Supplementary Notes 11 to 13, wherein the analysis unit excludes sensing data of a monitoring exclusion target from among sensing data superimposed on the optical signal, and analyzes the identified status information, based on remaining sensing data.

### Supplementary Note 15

The optical fiber sensing device according to any one of Supplementary Notes 11 to 14, wherein the analysis method related to the identified status information is a method of extracting a pattern related to the identified status information from sensing data superimposed on the optical signal, and analyzing the identified status information, based on the extracted pattern.

### REFERENCE SIGNS LIST

10 OPTICAL FIBER NETWORK
11 OPTICAL FIBER
20 OPTICAL FIBER SENSING DEVICE
21 COMMUNICATION UNIT
22 IDENTIFICATION UNIT
23 ANALYSIS UNIT
24 PROVIDING UNIT
30 COMPUTER
301 PROCESSOR
302 MEMORY
303 STORAGE
304 INPUT/OUTPUT INTERFACE
3041 DISPLAY DEVICE
3042 INPUT DEVICE
3043 SOUND OUTPUT DEVICE
305 COMMUNICATION INTERFACE

What is claimed is:

1. An optical fiber sensing system comprising:
an optical fiber network configured to detect sensing data;
a communication unit configured to receive an optical signal from the optical fiber network;
an identification unit configured to identify status information appropriate to a service providing destination from among a plurality of pieces of status information;
an analysis unit configured to analyze the identified status information, based on sensing data superimposed on the optical signal, by using an analysis method related to the identified status information among a plurality of analysis methods; and
a providing unit configured to provide the identified status information to the service providing destination.

2. The optical fiber sensing system according to claim 1, wherein the identification unit identifies status information of a monitoring exclusion target from among the plurality of pieces of status information, and identifies status information appropriate to the service providing destination, based on the identified status information of the monitoring exclusion target.

3. The optical fiber sensing system according to claim 1, wherein the identification unit identifies status information of a monitoring exclusion target appropriate to the service providing destination from among the plurality of pieces of status information, and identifies status information appropriate to the service providing destination, based on the identified status information of the monitoring exclusion target.

4. The optical fiber sensing system according to claim 1, wherein the analysis unit excludes sensing data of a monitoring exclusion target, from among sensing data superimposed on the optical signal, and analyzes the identified status information, based on remaining sensing data.

5. The optical fiber sensing system according to claim 1, wherein the analysis method related to the identified status information is a method of extracting a pattern related to the identified status information from sensing data superimposed on the optical signal, and analyzing the identified status information, based on the extracted pattern.

6. An optical fiber sensing method performed by an optical fiber sensing device, the method comprising:
a receiving step of receiving an optical signal from an optical fiber network configured to detect sensing data;
an identification step of identifying status information appropriate to a service providing destination from among a plurality of pieces of status information;
an analysis step of analyzing the identified status information, based on sensing data superimposed on the optical signal, by using an analysis method related to the identified status information among a plurality of analysis methods; and
a providing step of providing the identified status information to the service providing destination.

7. The optical fiber sensing method according to claim 6, wherein the identification step includes identifying status information of a monitoring exclusion target from among the plurality of pieces of status information, and identifying status information appropriate to the service providing destination, based on the identified status information of the monitoring exclusion target.

8. The optical fiber sensing method according to claim 6, wherein the identification step includes identifying status information of a monitoring exclusion target appropriate to the service provision destination from among the plurality of pieces of status information, and identifying status information appropriate to the service provision destination, based on the identified status information of the monitoring exclusion target.

9. The optical fiber sensing method according to claim 6, wherein the analysis step includes excluding sensing data of a monitoring exclusion target from among sensing data superimposed on the optical signal, and analyzing the identified status information, based on remaining sensing data.

10. The optical fiber sensing method according to claim 6, wherein the analysis method related to the identified status information is a method of extracting a pattern related to the identified status information from sensing data superimposed on the optical signal, and analyzing the identified status information, based on the extracted pattern.

11. An optical fiber sensing device comprising:
at least one memory storing instructions, and
at least one processor configured to execute the instructions to;
receive an optical signal from an optical fiber network configured to detect sensing data;
identify status information appropriate to a service providing destination from among a plurality of pieces of status information;
analyze the identified status information, based on sensing data superimposed on the optical signal, by using an analysis method related to the identified status information among a plurality of analysis methods; and
to provide the identified status information to the service providing destination.

12. The optical fiber sensing device according to claim 11, wherein the at least one processor is further configured to execute the instructions to identify status information of a monitoring exclusion target from among the plurality of pieces of status information, and identify status information appropriate to the service providing destination, based on the identified status information of the monitoring exclusion target.

13. The optical fiber sensing device according to claim 11, wherein the at least one processor is further configured to execute the instructions to identify status information of a monitoring exclusion target appropriate to the service providing destination from among the plurality of pieces of status information, and identify status information appropriate to the service providing destination, based on the identified status information of the monitoring exclusion target.

14. The optical fiber sensing device according to claim 11, wherein the at least one processor is further configured to execute the instructions to exclude sensing data of a monitoring exclusion target from among sensing data superimposed on the optical signal, and analyze the identified status information, based on remaining sensing data.

15. The optical fiber sensing device according to claim 11, wherein the analysis method related to the identified status information is a method of extracting a pattern related to the identified status information from sensing data superimposed on the optical signal, and analyzing the identified status information, based on the extracted pattern.
